(19) United States
(12) Patent Application Publication
(10) Pub. No.: US 2026/0254391 A1
(43) Pub. Date: Aug. 27, 2026

(54) MODULATION TECHNIQUES FOR IMPROVED INVERTER AND ELECTRIC MOTOR OPERATION

(71) Applicant: Caterpillar Inc., Peoria, IL (US)

(72) Inventors: Zeljko Jankovic, Mequon, WI (US); Srevidhya Devi, Chennai (IN); Rahul Mishra, Madhya Pradesh (IN); Likhita Ravuri, Peoria, IL (US); Thomas M. Sopko, East Peoria, IL (US); Jackson Wai, Dunlap, IL (US); Ahmed Khalil, Dunlap, IL (US)

(21) Appl. No.: 19/060,207

(22) Filed: Feb. 21, 2025

(51) Int. Cl. H02P 27/08

(52) U.S. Cl. CPC H02P 27/085

(57) ABSTRACT

An electric motor is driven by modulating an inverter that supplies energy to the motor. Clamp modulation is used to produce an output line-to-line voltage, which enable the generation of direct current (DC) or low-frequency alternating current (AC) currents. The clamp modulation generates different combinations of switch states that result in zero output line-to-line voltage, which distributes losses between the switches and diodes differently. The distribution lowers the junction temperatures of the switches and diodes, thereby increasing the inverter's reliability and efficiency. The method can be implemented using either a carrier-based approach, which injects a common mode signal into the modulation signal, or a direct switch state vector-based approach, which uses various combinations of switch states in terms of order and time duration.

### TECHNICAL FIELD

The present application is related to implementing thermal management of inverters that control electric motors in mining and construction equipment.

### BACKGROUND

Conventional motor drive systems in mining and construction industry applications can experience severe and prolonged low-speed and stall conditions. The typical torque speed characteristic for such systems indicates that the highest currents occur during stall and low-speed operations. During stall, a traction motor can enter a locked rotor state, drawing high-magnitude direct current (DC) currents (in the case of synchronous motors) or very low-frequency alternating current (AC) currents (for induction motors), depending on the motor type. This scenario is similar during low-speed operation, where the traction motor can draw very low-frequency AC currents for both synchronous and induction motors. The high-magnitude DC/low-frequency AC currents during stall/low-speed operations can result in higher junction temperature conditions for inverter switches / diodes within a given operating torque speed characteristic. Consequently, stall/low-speed operations can impose thermal limits on the systems, which in turn dictate the selection of inverter semiconductor devices for specific applications.

Publication US20160373047 discloses a method to estimate junction temperatures of semiconductor devices for each phase of an inverter, however, the publication does not address DC-stall operating conditions and requires a special thermal manager to identify the hottest electronic device in operation. There is therefore a need for improved traction inverter modulation techniques for reducing junction temperatures.

### SUMMARY

This document discloses methods, systems, and apparatuses for implementing improved inverter modulation techniques for reducing junction temperatures during stall and low-speed motor operation. The disclosed inverter modulation scheme can be used for motor drive systems used in mining and construction industry applications. Such systems can face severe and prolonged stall conditions, leading to high direct current (DC) or low-frequency alternating current (AC) currents that can cause maximum junction temperatures in inverter switches and diodes. For example, DC waveforms are generated for synchronous motors at a mechanical speed of 0 Hertz (Hz) frequency. The disclosed methods reduce such maximum junction temperatures by producing output line-to-line voltages for electric motors using different combinations of switch states that result in zero output line-to-line voltage. The produced combination of zero motor voltage switch states distributes losses differently among switches and diodes of the inverter, reducing the maximum junction temperatures compared to conventional modulation schemes. The disclosed systems can also be used for medium-speed or high-speed traction applications, grid-tie inverter applications, and other fixed and variable frequency non-traction inverter applications where sizing is dictated by operating conditions different from stall/low-speed conditions. The disclosed methods can be implemented via carrier-based or direct switch state vector-based methods, enhancing inverter reliability, reducing size and cost, and increasing torque capability.

In some implementations, an electric motor is driven by modulating an inverter that supplies energy to the motor. Clamp modulation is used to produce an output line-to-line voltage, which enables the generation of DC or low-frequency AC currents. The clamp modulation generates different combinations of switch states that result in zero output line-to-line voltage, which effectively distributes losses between the switches and diodes differently. The distribution lowers the junction temperatures of the switches and diodes, thereby enhancing the inverter's reliability and efficiency. The method can be implemented using either a carrier-based approach, which injects a common mode signal into the modulation signal, or a direct switch state vector-based approach, which uses various combinations of switch states in terms of order and time duration. This method significantly improves thermal management, reduces the size and cost of the inverter, increases torque capability, and boosts overall system reliability.

In some implementations, a controller for an electric motor, which receives power from an inverter modulates the inverter to improve efficiency and reliability by reducing thermal stress on components. The controller produces an output line-to-line voltage to generate necessary DC or low-frequency AC currents and utilizes different combinations of switch states that generate a zero output line-to-line voltage. By distributing losses differently between switches and diodes, the controller reduces junction temperatures. The modulation can be implemented using carrier-based mechanisms, which involve injecting a common mode signal into the modulation signal, or direct switch state vector-based mechanisms, which use different combinations of switch states in terms of order and time duration.

In some implementations, a work machine includes an electric motor, an inverter to supply power to the motor, and a controller designed to modulate the inverter. The controller produces an output line-to-line voltage for the motor to generate DC or low-frequency AC currents. The controller uses different combinations of switch states that result in a zero output line-to-line voltage to effectively distribute losses between switches and diodes. The controller lowers junction temperatures of the switches and diodes, particularly during stall and low-speed motor operations. The controller enhances thermal management, thereby improving the efficiency and reliability of the work machine.

### BRIEF DESCRIPTION OF THE DRAWINGS

FIG. 1 is a block diagram that illustrates an example work machine for improved inverter modulation, in accordance with some aspects of the present technology.

FIG. 2 illustrates an implementation of an example work machine including an inverter topology for improved modulation, in accordance with some aspects of the present technology.

FIG. 3 is a flowchart that illustrates an example process for improved inverter modulation, in accordance with some aspects of the present technology.

FIG. 4 is a flowchart that illustrates an example process for inverter modulation for reducing junction temperatures, in accordance with some aspects of the present technology.

FIG. 5 is a flowchart that illustrates an example process for inverter modulation during stall and low-speed motor operation, in accordance with some aspects of the present technology.

FIG. 6 is a block diagram that illustrates an example of a computer system in which at least some operations described herein can be implemented.

### DETAILED DESCRIPTION

This document discloses methods, systems, and apparatuses for implementing improved inverter modulation techniques for reducing junction temperatures during stall and low-speed motor operation. The disclosed systems can also be used for medium-speed or high-speed traction applications, grid-tie inverter applications, and other fixed and variable frequency non-traction inverter applications where sizing is dictated by operating conditions different from stall/low-speed conditions. The disclosed methods for inverter modulation address the thermal challenges faced by motor drive systems in the mining and construction industries. Such systems often operate under severe and prolonged low-speed and stall conditions, which can result in high magnitude direct current (DC) currents for synchronous motors and very low frequency alternating current (AC) currents for induction motors operating in true 0 Hz stall conditions. Such conditions can lead to higher junction temperatures experienced by inverter switches and diodes, dictating the thermal limits and limiting the selection of semiconductor devices. The systems for traction inverter modulation disclosed herein reduce the junction temperatures of switches and diodes. The disclosed modulation methods cause the output line-to-line voltage of the motor to produce the necessary DC/low-frequency AC currents using different combinations of switch states that result in a zero output line-to-line voltage. By distributing the losses between switches and diodes differently, the disclosed apparatuses reduce the junction temperatures compared to conventional modulation techniques.

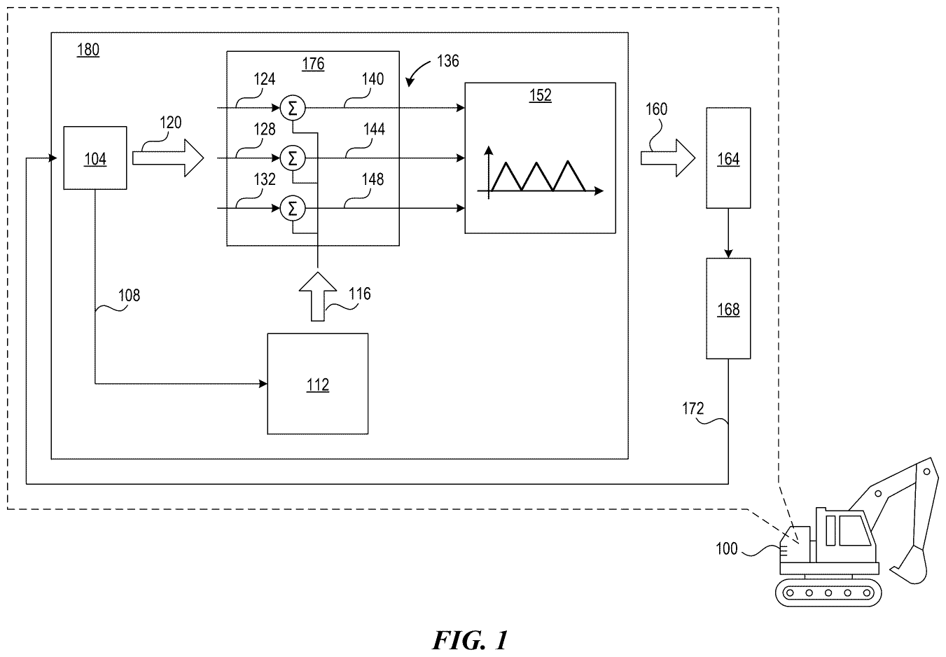

FIG. 1 is a block diagram that illustrates an example work machine 100 for improved traction inverter modulation, in accordance with some aspects of the present technology. The exemplary work machine 100 is an excavator used in construction or mining. The work machine 100 is a heavy machinery vehicle powered by an electric motor, which can drive a hydraulic pump to operate the excavator's arm, bucket, and/or tracks. For example, electric power can be supplied to the work machine 100 by a trailing cable connected to a power source on site. The modulation techniques for electric motors disclosed herein can be implemented in many different work machines, such as excavators, wheel loaders, winches, hoists, and rotary kilns to drive equipment such as crushers, conveyors, fans, pumps, and mills. The work machine 100 includes an electric motor 168, an inverter 164, and a controller 180. The electric motor 168 and inverter 164 are sometimes referred to as a motor drive system, and the controller 180 is sometimes referred to as a motor drive controller. Likewise, embodiments of example work machine 100 can include different and/or additional components or can be connected in different ways.

The work machine 100 is configured for improved inverter modulation to reduce junction temperatures, e.g., during stall and low-speed motor operation. The controller 180 includes components for implementing thermal management through modulation control of the inverter 164 that supplies power to drive the electric motor 168 (sometimes referred to as a traction motor). The components include electronic circuitry 104, a common mode signal generator 112, a clamp control module 176, and a pulse width modulation module 152. The controller 180 receives information 172, e.g., from the electric motor 168 or from other circuitry. The information 172 can include three-phase voltage reference signals and three-phase current signals associated with operation of the electric motor 168. During stall conditions, the electric motor 168 operates in a locked rotor state and draws high-magnitude DC currents for synchronous motors or very low-frequency AC currents for induction motors. For example, in low-speed operation up to 0.5 revolutions per minute (rpm), the motor 168 draws very low-frequency AC currents with frequencies up to 10 Hertz (Hz) for both synchronous and induction motor types.

The common mode signal generator 112 is configured to determine voltage values among the three-phase voltage reference signals. The common mode signal generator 112 identifies which of the three voltage reference signals has a maximum value (V_{high}) and which has a minimum value (V_{low}). The controller 180 identifies corresponding three-phase currents by analyzing which phases have the maximum and minimum voltage values determined from the voltage reference signals. When a particular phase voltage is identified as V_{low}, the controller 180 assigns that phase's current as I_{low}. In some example implementations, the disclosed current identification process can handle phase currents ranging from approximately 1,200 Amperes (A) during stall conditions at 0 Hz to peak currents of approximately 1,700 A during low-speed operation at approximately 0.1 rpm.

The electronic circuitry 104 sends information 108 to the common mode signal generator 112. The information 108 can include V_{clamp} values used for generating a common mode signal V_{cm} as well as the three-phase voltage reference signals and three-phase current signals associated with operation of the electric motor 168. The common mode signal generator 112 generates the common mode signal V_{cm} by comparing the absolute values of the identified phase currents I_{high} and I_{low} using the mathematical comparison |I_{high}|>|I_{low}|. Based on this comparison, the common mode signal generator 112 selects an appropriate V_{clamp} value, e.g., between 0 and Vₘₐₓ, and generates the common mode signal V_{cm}. The common mode signal generator 112 generates and sends the signal 116 denoted by the symbol m_{cm(abc)} to the clamp control module 176. The signal 116 is generated using the mathematical function m_{cm(abc)}=modulation index×V_{cm(abc)}.

In some implementations, the clamp control module 176 modifies reference modulation signals 120 using carrier-based modulation by adding the generated common mode signal to produce clamped modulation signals 136. For stall conditions, these scaled reference signals (124, 128, 132) can have modulation indices ranging from approximately −0.02 to 0.2, while during low-speed operation the modulation indices can range from approximately −0.14 to 0.14. In some example implementations, for a two-level topology of the inverter 164 with 1,200 A DC currents, injecting the common mode signal modifies the modulation indices from mₐ=0.04(124 ), m_{b}=−0.02 (128), m_{c}=−0.02 (132) to clamped values of m_{aclamp}=0.2 (140), m_{bclamp}=0.14 (144), m_{cclamp}=0.14 (148). The modified signals 136 can be compared by the pulse width modulation module 152 with triangular carrier waveforms, e.g., at 500 Hz switching frequency, to generate the pulse width modulation gate pulses 160.

For example, the pulse width modulation module 152 compares the clamped modulation signals 136 with triangular carrier signals using a pulse width modulation generator to produce gate pulses 160 (pulse width modulation pulses) that control the switching devices. The pulse width modulation module 152 can operate at a switching frequency of approximately 500 Hz for both stall and low-speed conditions. During stall operation, the clamped signals 136 are compared against the carrier waveforms to generate the pulse width modulation pulses 160. The controller 180 uses the pulse width modulation gate pulses 160 to control the switching devices in the inverter 164 (sometimes referred to as a traction inverter).

For a two-level inverter topology, the controller 180 applies the pulse width modulation pulses 160 to control the switches while maintaining an example 500 Hz switching frequency. When operating at stall, the controller 180 can drive the switches to produce an example 50 Volt (V) line-to-line output voltage while balancing temperatures between Insulated Gate Bipolar Transistors (IGBTs) at approximately 148° Celsius (C.) and diodes at approximately 154° C. For example, the work machine 100 operates with a DC link voltage of approximately 750 V and motor AC terminal line-to-line voltage of approximately 50 V, with switching frequencies of 500 Hz during both stall and low-speed conditions. These operating conditions dictate the highest thermal stress on the inverter components, necessitating thermal management through modulation control. The controller's modulation technique can enable up to 200% increase in stall time capability through balanced thermal stress distribution while maintaining the required output voltage characteristics. Through this configuration, the work machine 100 achieves improved thermal management of the inverter 164 during stall and low-speed operation of the electric motor 168. The controller 180 effectively reduces maximum junction temperatures of switches and diodes while maintaining the required output performance characteristics. This enables either reduced inverter size and cost for a given machine application, or increased stall/low-speed machine torque capability for a given inverter design.

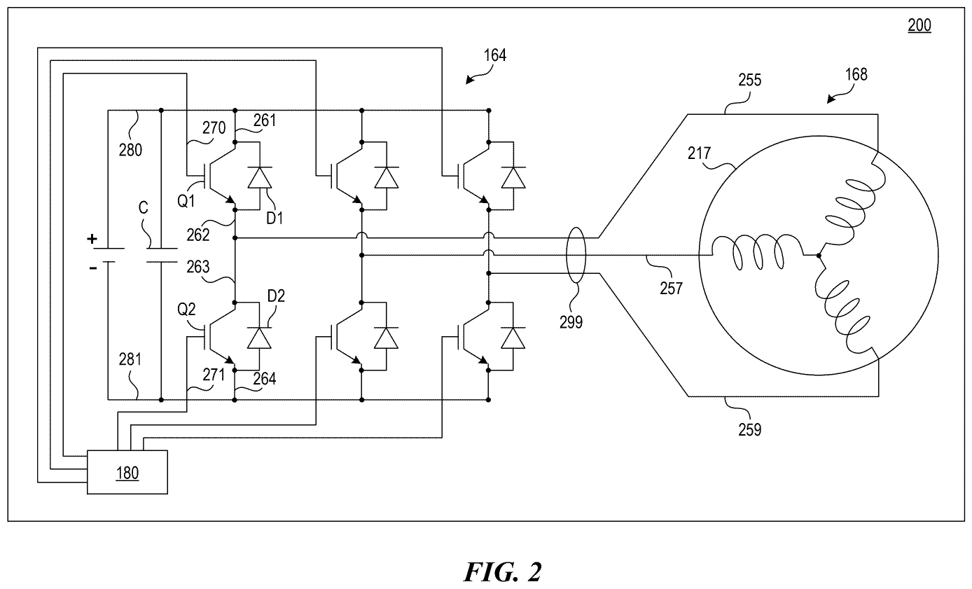

FIG. 2 illustrates an implementation of an example work machine 200 including an inverter topology for improved traction inverter modulation, in accordance with some aspects of the present technology. The work machine 200 is the same as or similar to the work machine 100 described with reference to FIG. 1. The work machine 200 can be an excavator, a wheel loader, a winches, a hoist, or a rotary kiln that drives equipment such as crushers, conveyors, fans, pumps, and/or mills. The work machine 200 includes an electric motor 168, an inverter 164, and a controller 180. Examples of the electric motor 168, inverter 164, and controller 180 are also shown by FIG. 1. Likewise, embodiments of example work machine 200 can include different and/or additional components or can be connected in different ways.

The inverter 164 shown by FIG. 2 has three output phases: Phase A (255), Phase B (257) and Phase C (259). The example semiconductor devices in the inverter 164 include semiconductor switches (Q1, Q2), diodes (D1, D2), or both. Each output phase has a high-side switch (Q1) and a low-side switch (Q2). Each high-side switch can have switched terminals (261, 262) and a control terminal 270. Similarly, each low-side switch can have switched terminals (263, 264) and a control terminal 271. A first switched terminal 261 of each high-side switch is coupled to a positive DC supply 280 or a bus. A first switched terminal 264 of each low-side switch is coupled to a negative DC supply 281 or a bus. As illustrated, a second switched terminal 262 of the high-side switch is coupled to a second switched terminal 263 of the low-side switch to provide an output signal such as a pulse width modulated output signal for a single phase.

Each high-side diode (D1) may be placed in parallel with the switched terminals (261, 262) of a corresponding high side switch (Q1) and each low-side diode (D2) may be placed in parallel with the switched terminals (263, 264) of the corresponding low-side switch (Q2). For each semiconductor switch, the switched terminals (261, 262, 263, 264) can refer to the emitter and collector if the semiconductor switch is a transistor, or the switching terminals can refer to the source and drain if the semiconductor device is a field effect transistor. A control terminal (e.g., base or gate) of the semiconductor device is coupled to the controller 180.

The controller 180 can include electronic circuits, microcontrollers, a programmable logic array, a microprocessor, or another data processor that is adapted to provide driving signals to the control terminals (270, 271). For example, the controller 180 provides a set of control signals to the control terminals (270, 271) of the low-side switch (Q2) and the high-side switch (Q1) for each phase in a synchronized or coordinated manner. The controller 180 alters or adjusts the duration and phase (or polarity) of the control signals applied to the inverter 164 to control the control terminals of the switches (Q1-Q2) to adjust heat distribution among the semiconductor devices (Q1-Q2 and D1-D2, inclusive).

The durations of certain control signals or the ratio of the durations of certain control signals applied by the controller 180 to certain ones of the control terminals (270, 271) of the switches for one or more phases determines the duty cycle or duty ratio for the semiconductor devices in one or more phases. In the typical IGBT-based inverter, the semiconductor device that is conducting is dependent on the current flow; the switch device (Q1) is not capable of reverse conduction such that the antiparallel diode (D1) coupled to the non-conducting switch device would conduct during the on portion of the cycle (e.g., of the driving waveform for the switch device). Shifting D can shift the conduction losses (or thermal dissipation) between the high-side and low-side semiconductor devices in a phase and can impact the maximum differential voltage output of the inverter.

The inverter topology shown by FIG. 2 is sometimes referred to as a two-level topology. Similarly, a three-level neutral point clamped topology uses 12 switching devices and includes additional clamping diodes that connect to a neutral point. Depending on the particular application, different inverter topologies can be used, such as a 4-level topology, a 5-level topology, etc. The disclosed modulation techniques can be beneficial for other types of inverter topologies as well, such as active neutral point clamped topology, flying capacitor topology, T-type topology, cascaded H bridge topology, and other multi-level topologies. In some example implementations, during stall conditions with 1,200 A phase currents, the two-level topology achieves balanced temperatures of 148° C. between IGBTs and diodes using a common mode signal with V_{clamp}=0.2, while for the three-level neutral point clamped topology, V_{clamp} can be set to 0.4 to maintain IGBTs at 85° C. while reducing neutral point clamped diode temperatures by 25° C. In some example implementations, the three-level topology provides enhanced thermal management capabilities, enabling operation with RMS phase currents of 635 A while maintaining the same 750 V DC link voltage and 50V line-to-line output voltage requirements.

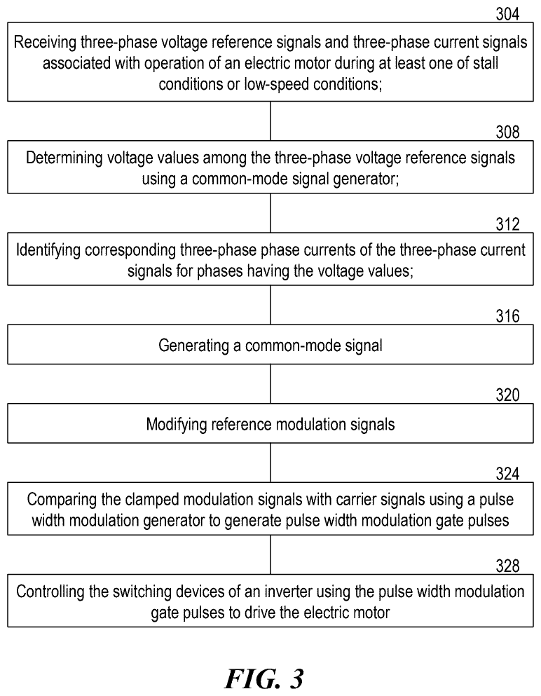

FIG. 3 is a flowchart that illustrates an example process for improved traction inverter modulation, in accordance with some aspects of the present technology. In some implementations, the process is performed by the controller 100 illustrated and described in more detail with reference to FIG. 1. Particular entities, for example, the electronic circuitry 104 or the common mode signal generator 112 (shown by FIG. 1) perform some or all of the steps of the process in other implementations. Likewise, implementations can include different and/or additional steps or can perform the steps in different orders.

At 304, a controller receives three-phase voltage reference signals and phase current signals from a motor drive system during stall and/or low-speed operating conditions. The three-phase voltage reference signals are denoted as Vₐ*, V_{b}*, and V_{c}* for the three phases. The corresponding phase current signals are denoted as Iₐ, I_{b}, and I_{c}. When determining maximum and minimum values, the signals are also referenced as V_{high} and V_{low} for the voltage signals, with their corresponding current signals denoted as I_{high} and I_{low}. During stall conditions, a traction motor operates in a locked rotor state and draws high magnitude DC currents for synchronous motors or very low frequency AC currents for induction motors. For low-speed operation, which can include speeds up to 0.5 revolutions per minute (rpm), the motor draws very low frequency AC currents with frequencies up to 10 Hertz (Hz) for both synchronous and induction motor types. The controller processes these input signals to generate reference modulation signals m_{abc}.

The voltage and current signals are used to determine maximum and minimum values among the three phases, with peak phase currents that can reach approximately 1,700 Amps (A) during low speed operation and approximately 1,200 A during stall conditions, in some examples. The system can operate with a DC link voltage of approximately 750 Volts (V) and motor AC terminal line-to-line voltage of approximately 50 V, with switching frequencies of 500 Hz during both stall and low-speed conditions. These operating conditions dictate the highest thermal stress on the inverter components, necessitating thermal management through modulation control.

At 308, the controller uses a common mode signal generator to determine voltage values by analyzing the three-phase voltage reference signals Vₐ*, V_{b}*, and V_{c}*. The controller generates reference modulation signals (mₐ, m_{b}, m_{c}) based on field oriented control for either synchronous or induction machines. For example, the controller receives torque and speed commands and produces the voltage reference signals and current reference signals (Iₐ, I_{b}, I_{c}) needed to control the motor. The common mode signal generator identifies which of the three voltage reference signals has a maximum value (V_{high}) and which has a minimum value (V_{low}). In some example implementations, for stall conditions, the voltage reference signals can have modulation indices ranging from approximately −0.02 to 0.2, while during low-speed operation the modulation indices can range from approximately −0.14 to 0.14. The common mode signal generator assigns the corresponding phase currents (Iₐ, I_{b}, or I_{c}) to I_{high} or I_{low} based on which phase voltage was identified as maximum or minimum. For example, if V_{b}* is determined to be V_{high}, then I_{b} is assigned as I_{high}. This voltage determination process is performed continuously during both stall conditions and low-speed conditions.

At 312, the controller identifies corresponding three-phase currents (Iₐ, I_{b}, I_{c}) by analyzing which phases have the maximum and minimum voltage values (V_{high} and V_{low}) determined from the voltage reference signals Vₐ*, V_{b}*, and V_{c}*. When a particular phase voltage is identified as V_{low}, the controller assigns that phase's current as I_{low}—for example, if Vₐ* is identified as V_{low}, then Iₐ is assigned as I_{low}. This current identification process can handle phase currents ranging from approximately 1,200 A during stall conditions at 0 Hz to peak currents of approximately 1,700 A during low-speed operation at approximately 0.1 rpm. For a three-level neutral point clamped topology, the controller can process root mean square (RMS) phase currents of approximately 635 A while operating with a DC link voltage of approximately 750 V and motor AC terminal line-to-line voltage of approximately 50 V. The controller continuously performs this current identification process during both stall conditions and low-speed conditions.

At 316, the controller generates a common mode signal by comparing the absolute values of the identified phase currents I_{high} and I_{low} using the mathematical comparison |I_{high}|>|I_{low}|. For example, the controller determines whether |I_{high}|>|I_{low}|by comparing absolute values of phase currents after identifying which phases correspond to the maximum voltage value (V_{high}) and minimum voltage value (V_{low}). Based on the comparison of |I_{high}|and |I_{low}|, the controller selects an appropriate V_{clamp} value, e.g., between 0 and Vₘₐₓ and generates the common mode signal V_{cm}. Based on the comparison, the controller generates the common mode signal (V_{cm}) using one of two formulas: if |I_{high}|>|I_{low}|, then V_{cm}=V_{clamp}−V_{high}, or if |I_{high}|<|I_{low}|, then V_{cm}=−V_{clamp}−V_{low}.

The V_{clamp} value can be selected from a range between 0 and Vₘₐₓ to achieve approximate temperature balancing between the switching devices and diodes. When a true balance of temperatures cannot be achieved, the V_{clamp} value is considered based on reducing the higher temperature value between two devices. For example, during stall conditions a V_{clamp} value of 0.2 balances IGBT and diode temperatures at 148° C., reducing diode temperatures by up to 17° C. For three-level topology operation with RMS currents of 635 A, a V_{clamp} value of 0.4 can reduce neutral point clamped diode temperatures by up to 25° C. The common mode signal generation process operates continuously during both stall conditions and low-speed conditions up to 10 Hz, maintaining the required output line-to-line voltage of 50 V while redistributing thermal stress.

At 320, in some implementations the controller modifies the reference modulation signals (mₐ, m_{b}, m_{c}) using carrier-based modulation by adding the generated common mode signal (V_{cm}) to produce clamped modulation signals (m_{aclamp}, m_{bclamp}, m_{cclamp}). For a two-level topology with 1,200 A DC currents, injecting the common mode signal can modify the modulation indices from ma =0.04, mb=−0.02, mc=−0.02 to clamped values of ma=0.2, mb=0.14, mc=0.14. The modified signals can then be compared with triangular carrier waveforms at a 500 Hz switching frequency to generate the pulse width modulation gate pulses. For a two-level topology operating at stall conditions, adding a common mode signal with V_{clamp}=0.2 changes the modulation indices from initial values of mₐ=0.04, m_{b}=−0.02, m_{c}=−0.02 to clamped values of 0.2, 0.14, 0.14. This redistribution can reduce diode junction temperatures from approximately 166° C. to approximately 154° C. while maintaining a required line-to-line output voltage.

For three-level topology operation, adding a common mode signal with V_{clamp}=0.4 modifies the modulation signals to achieve up to approximately 25° C. reduction in neutral point clamped diode temperatures. This modification process maintains the required output voltage while enabling up to approximately 200% increase in stall time capability through balanced thermal stress distribution. In some implementations, the controller implements direct switch state vector-based modulation by controlling different combinations of switch states in terms of order and time duration while maintaining a 500 Hz switching frequency. This implementation achieves the same thermal balancing effects as carrier-based modulation but uses direct digital control of switching states rather than comparing modulation signals against carriers. The controller determines the switch state combinations and timing to maintain the required 50V line-to-line output voltage while redistributing thermal stress between switching devices and diodes.

At 324, the controller compares the clamped modulation signals (m_{aclamp}, m_{bclamp}, m_{cclamp}) with triangular carrier signals using a pulse width modulation generator to produce gate pulses that control the switching devices. The pulse width modulation generator can operate at a switching frequency of approximately 500 Hz for both stall and low-speed conditions. During stall operation, the clamped signals are compared against the carrier waveforms to generate the pulse width modulation pulses. For low-speed operation, the comparison process uses clamped signals that can range from −0.14 to 0.14 in modulation index. In a three-level topology implementation, the pulse width modulation generator compares clamped signals using modulation indices up to ±0.4 against the carrier signals. The comparison process generates pulse width modulation gate pulses that maintain the required line-to-line output voltage while enabling balanced thermal distribution between switching devices and diodes through modified duty cycles.

At 328, the controller uses the pulse width modulation gate pulses to control the switching devices in the inverter. For a two-level inverter topology, the controller applies the pulse width modulation pulses to control the switches while maintaining an approximately 500 Hz switching frequency. In some example implementations, when operating at stall, the controller drives the switches to produce a 50 V line-to-line output voltage while balancing temperatures between IGBTs at approximately 148° C. and diodes at approximately 154° C. For example, during stall conditions with 1,200 A DC currents, the controller can reduce junction temperatures by implementing a clamp control strategy with V_{clamp}=0.2, which reduces diode temperatures from approximately 166° C. to approximately 154° C. while maintaining IGBT temperatures at approximately 148° C. The temperature reduction enables increased stall time capability from approximately 6.3 seconds to approximately 12.9 seconds at 150° C. junction temperature limits while maintaining 50V line-to-line output voltage and 500 Hz switching frequency. For a three-level neutral point clamped topology, the controller can achieve balanced thermal distribution, with IGBT temperatures at approximately 85° C. and neutral point clamped diode temperatures reduced by up to approximately 25° C.

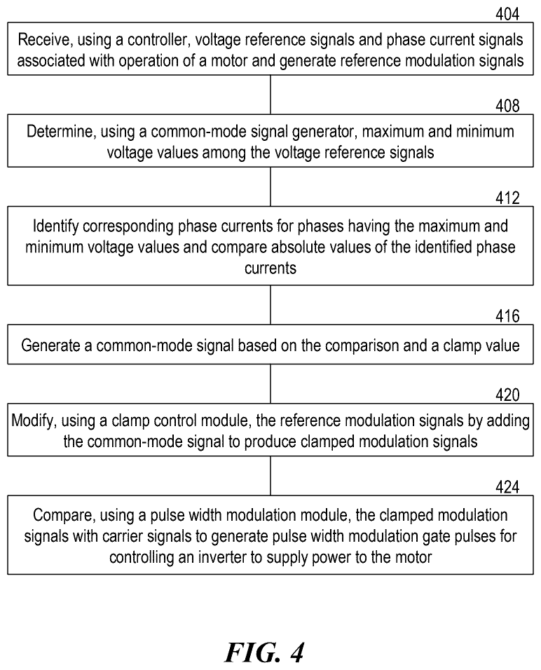

FIG. 4 is a flowchart that illustrates an example process for traction inverter modulation for reducing junction temperatures, in accordance with some aspects of the present technology. In some implementations, the process is performed by the controller 180 illustrated and described in more detail with reference to FIG. 1. Particular entities, for example, the electronic circuitry 104 or the common mode signal generator 112 (shown by FIG. 1) perform some or all of the steps of the process in other implementations. Likewise, implementations can include different and/or additional steps or can perform the steps in different orders.

At 404, a controller uses electronic circuitry to receive voltage reference signals (Vₐ*, V_{b}*, V_{c}*) and phase current signals (Iₐ, I_{b}, I_{c}) from a motor drive system during stall conditions with approximately 1,200 A DC currents or low-speed operation up to approximately 10 Hz with approximately 1,700 A peak currents. The electronic circuitry processes these signals to generate reference modulation signals (mₐ, m_{b}, m_{c}) that correspond to a required output line-to-line voltage. For stall operation, the electronic circuitry generates DC modulation signals (mₐ=0.04, m_{b}=−0.02, m_{c}=−0.02), while for low-speed operation it generates sinusoidal reference waveforms.

At 408, the controller uses a common mode signal generator to determine V_{high} and V_{low} by comparing the three voltage reference signals to identify which phase has the maximum voltage value (V_{high}) and which has the minimum voltage value (V_{low}). For example, the voltage having the highest peak is determined by computing maximum(Vₐ*, V_{b}*, V_{c}*) to identify V_{high}. Simultaneously, the voltage having the lowest value is determined by computing minimum(Vₐ*, V_{b}*, V_{c}*) to identify V_{low}. During stall conditions, this comparison process continuously evaluates the reference signals to determine which phase voltages should be assigned as V_{high} and V_{low}. The voltage identification process operates in conjunction with the subsequent current assignment and common mode signal generation to achieve balanced thermal distribution between switching devices.

At 412, the controller uses the common mode signal generator to assign phase currents I_{high} and I_{low} based on the identified voltage values, e.g., when a phase voltage is identified as V_{high}, its corresponding phase current is assigned as I_{high}. The common mode signal generator compares the absolute values of the identified phase currents |I_{high}| and |I_{low}| to determine which current magnitude is larger. For example, during stall conditions if phase B has the maximum voltage and phase A has the minimum voltage, |I_{b}| and |Iₐ| are compared. This absolute value comparison determines whether to add or subtract the clamp value when generating the common mode signal−if |I_{high}|>|I_{low}|, then V_{cm}=V_{clamp}−V_{high}, otherwise if |I_{high}|<|I_{low}|, then V_{cm}=−V_{clamp}−V_{low}.

At 416, the controller uses the common mode signal generator to produce V_{cm} based on comparing |I_{high}| and |I_{low}| and using a clamp value that can range from, e.g., 0 to 1, or 0% to 100%, or 0 to 100. Different normalized ranges can be used. The controller selects the clamp value based on analyzing temperature distribution between switching devices. For example, during stall conditions a clamp value of 0.2 is selected to balance IGBT and diode temperatures at 148° C. For three-level neutral point clamped topology, a clamp value of 0.4 can balance temperatures by reducing neutral point clamped diode temperatures by 25° C. while maintaining IGBT temperatures at 85° C. The clamp value selection is based on specific design parameters including switching frequency, motor parameters, power modules selected, and operating point conditions.

At 420, in some implementations, the controller uses a clamp control module to add the generated common mode signal V_{cm} to each of the reference modulation signals to produce clamped modulation signals. In some example implementations, the clamped modulation signals are then compared with a 500 Hz triangular carrier waveform to generate the pulse width modulation gate pulses that achieve balanced IGBT and diode temperatures. In some implementations, a space vector modulation can be used, which can have a simpler implementation but can result in higher diode temperatures (166° C. vs 154° C.) during stall conditions and can have limited stall duration capability compared to clamp modulation. In some cases, offset signal injection can be used that injects offset/common mode signals based on temperature estimation. Multiple different offset signals can be used. In some cases, a thermal manager with current limiting can be used to estimate hottest device temperatures and reduce current accordingly.

At 424, in some implementations, the controller uses a pulse width modulation module to compare the clamped modulation signals with 500 Hz triangular carrier waveforms to generate width modulation gate pulses that control the switching devices of the inverter. For example, during stall conditions the module compares the clamped signals with the carrier to generate gate pulses that achieve balanced 148° C. temperatures between IGBTs and diodes. The clamp value is selected based on the operating conditions and design parameters. For example, during stall conditions with a 350 kilowatt (kW) motor, a clamp value of 0.2 can be used to balance IGBT and diode temperatures at 148° C. This example value is determined for a 350 kW distributed winding motor, a 750V DC link voltage, a 50V line-to-line output voltage, and a 500 Hz switching frequency. The clamp value is determined using thermal analysis of the specific motor and inverter configuration being used.

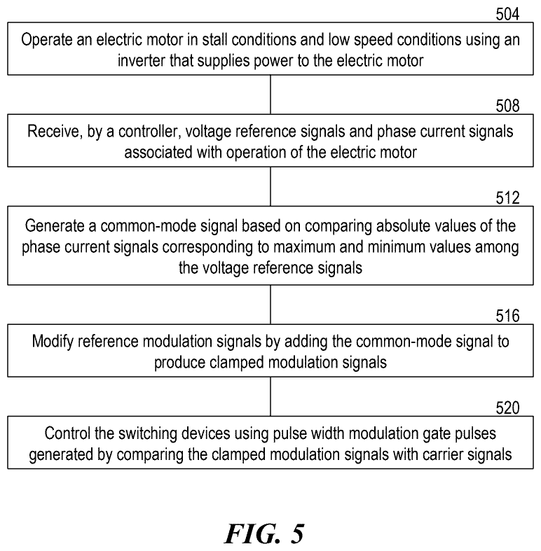

FIG. 5 is a flowchart that illustrates an example process for traction inverter modulation during stall and low-speed motor operation, in accordance with some aspects of the present technology. In some implementations, the process is performed by the work machine 100 illustrated and described in more detail with reference to FIG. 1. Particular entities, for example, the controller 180 (shown by FIG. 1) perform some or all of the steps of the process in other implementations. Likewise, implementations can include different and/or additional steps or can perform the steps in different orders.

At 504, a work machine operates an electric motor in stall conditions and low speed conditions using an inverter that supplies power to the electric motor. For example, the work machine includes a 350 kW distributed winding electric motor that operates in stall conditions and low speed conditions. The inverter includes IGBTs and diodes configured in either a two-level topology with 6 IGBTs/diodes or three-level neutral point clamped topology.

At 508, the work machine uses the controller to receive three-phase voltage reference signals and phase current signals, e.g., from an electric motor. During stall conditions, these signals can include DC voltage references producing 50 V line-to-line output voltage and phase currents up to 1,200 A, while at low speeds such as 0.1 rpm, the controller can receive AC voltage references and phase currents up to 1,700 A peak. The controller processes these signals at 500 Hz switching frequency to generate the appropriate modulation signals for thermal management. The voltage and current signals serve as inputs to the common mode signal generator block, which generates the clamped modulation signals.

At 512, the work machine uses the controller to compare the absolute values of phase currents (I_{high}, I_{low}) corresponding to the identified maximum voltage (V_{high}) and minimum voltage (V_{low}) phases. For example, during stall conditions, this comparison process can generate a common mode DC signal of 0.2 that modifies the modulation indices to achieve balanced 148° C. temperatures between IGBTs and diodes.

At 516, the work machine uses the controller to add the generated common mode signal (V_{cm}) to the original reference modulation signals to produce the clamped modulation signals. For stall conditions, when the common mode signal V_{cm}=0.2 is added to the original modulation indices (mₐ=0.04, m_{b}=−0.02, m_{c}=−0.02), it produces clamped signals (m_{aclamp}=0.2, m_{bclamp}=0.14, m_{cclamp}=0.14) that achieve balanced 148° C. temperatures. For low speed operation, adding the common mode signal modifies the sinusoidal reference waveforms by clamping them to ±0.2 for 60 degrees of operation. In three-level neutral point clamped topology implementations, the common mode signal addition can produce clamped signals at ±0.4 to balance temperatures between IGBTs at 85° C. and reduce neutral point clamped diode temperatures by 25° C. The controller can select a V_{clamp} value between 0 and Vₘₐₓ based on the operating conditions to achieve optimal thermal balancing. For stall operation, the controller can set V_{clamp}=0.2 to modify the modulation indices to produce balanced 148° C. temperatures between IGBTs and diodes.

At 520, in some example implementations, the work machine controls the switching devices by comparing the clamped modulation signals with 500 Hz triangular carrier waveforms to generate pulse width modulation gate pulses. For a two-level topology as shown by FIG. 2, the comparison generates gate pulses that control 6 IGBTs/diodes. The pulse width modulation gate pulses generated by comparing the clamped modulation signals with triangular carriers control the switching sequence to achieve balanced thermal distribution between the two IGBTs and two diodes in each phase. For a three-level neutral point clamped topology, the pulse width modulation comparison controls 12 switching devices to maintain IGBTs at 85° C. while reducing neutral point clamped diode temperatures by 25° C. The gate pulses determine the conduction states and switching sequence of the devices to produce the required output voltage while maintaining optimal thermal distribution between switches and diodes.

### INDUSTRIAL APPLICABILITY

The disclosed apparatuses and systems for clamp modulation have broad applicability across multiple industrial sectors that use motor drive systems. In mining and construction applications, the technology enables improved thermal management during severe stall and low-speed conditions typical of heavy equipment operations. For vehicle electric powertrains, the technique can enhance inverter reliability and reduce hardware costs through better thermal balancing. The modulation scheme is particularly valuable for applications requiring high torque at low speeds, such as mining trucks, construction machinery, and industrial equipment where motors frequently operate in stall or near-stall conditions. The technology can be implemented in both two-level and three-level inverter topologies commonly used across these industries. For example, in mining applications with 750 V DC link voltage and 50 V line-to-line output requirements, the scheme enables up to 200% increase in stall duration capability while maintaining balanced temperatures between IGBTs and diodes.

The benefits and advantages of the implementations described herein include improved thermal management, efficiency, and reliability of work machines. The disclosed controller's ability to use different combinations of switch states that produce a zero output line-to-line voltage effectively distributes losses between switches and diodes. The balanced distribution prevents any single component from overheating, thereby reducing thermal stress. Additionally, the suppression of junction temperatures during stall and low-speed motor operations provides that the components operate within safe thermal limits, preventing potential damage and extending their lifespan. The improved modulation methods reduce switching losses, which can be a significant source of inefficiency in power electronics. The carrier-based implementation, which involves injecting a common mode signal into the modulation signal, and the direct switch state vector-based implementation, which uses various combinations of switch states, both contribute to reducing such losses. The reduced switching losses result in less heat generation and more efficient power conversion, leading to overall improved system efficiency.

The improved thermal management increases the reliability of the disclosed systems because components that are kept within preferred temperature ranges are less likely to fail. The disclosed methods result in fewer breakdowns and maintenance requirements, which is beneficial for work machines that often operate in demanding environments and require consistent performance. Furthermore, the lifespan of critical components such as switches and diodes is extended by preventing overheating and reducing thermal stress. The improved longevity translates to cost savings over time, as components do not need to be replaced as frequently. The improved modulation scheme can be realized through both carrier-based and direct switch state vector-based methods, providing flexibility in implementation. The improved versatility allows for adaptation to different types of work machines and operational requirements. In summary, the disclosed methods offer enhanced thermal management, improved efficiency, increased reliability, extended component lifespan, and versatile implementation.

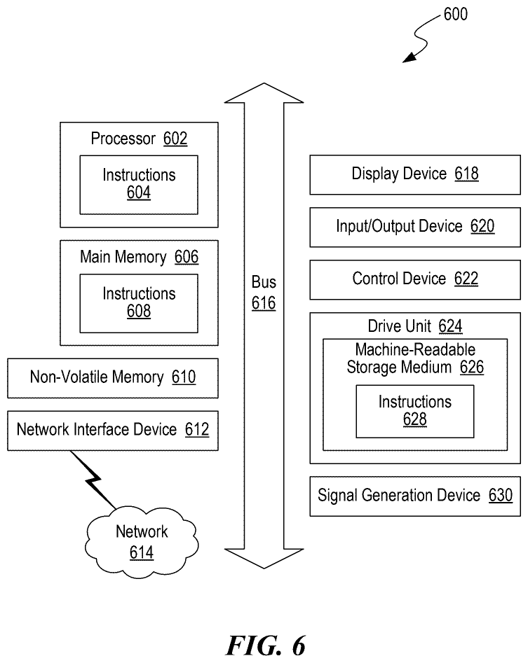

FIG. 6 is a block diagram that illustrates an example of a computer system 600 in which at least some operations described herein can be implemented. Components of the computer system 600 can be used to implement the work machines 100, 200 and the controller 180 shown by FIGS. 1-2.

As shown, the computer system 600 can include: one or more processors 602, main memory 606, non-volatile memory 610, a network interface device 612, video display device 618, an input/output device 620, a control device 622 (e.g., keyboard and pointing device), a drive unit 624 that includes a storage medium 626, and a signal generation device 620 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computer system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 600. In some implementation, the computer system 600 can be an embedded computer system, a system-on-chip (SOC), a single-board computer system (SBC) or a distributed system such as a mesh of computer systems or include one or more cloud components in one or more networks. Where appropriate, one or more computer systems 600 can perform operations in real-time, near real-time, or in batch mode.

The network interface device 612 enables the computer system 600 to mediate data in a network 614 with an entity that is external to the computer system 600 through any communication protocol supported by the computer system 600 and the external entity. Examples of the network interface device 612 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable (storage) medium 626 can include any medium that is capable of storing, encoding, or carrying a set of instructions for execution by the computer system 600. The machine-readable medium 626 can be non-transitory or include a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically include one or more instructions (e.g., instructions 604, 608, 628) set at various times in various memory and storage devices in computing device(s). When read and executed by the processor 602, the instruction(s) cause the computer system 600 to perform operations to execute elements involving the various aspects of the disclosure.

We claim:

1. A method of driving an electric motor, comprising:
receiving, by a controller, three-phase voltage reference signals and three-phase current signals associated with operation of the electric motor during at least one of stall conditions, wherein the electric motor draws direct current (DC) currents while in a locked rotor state, or low-speed conditions, wherein the electric motor draws low-frequency alternating current (AC) currents;
determining voltage values among the three-phase voltage reference signals using a common mode signal generator;
identifying corresponding three-phase phase currents of the three-phase current signals for phases having the voltage values;
generating a common mode signal by:
comparing absolute values of the corresponding three-phase phase currents; and
providing a clamp value selected to balance temperatures between switching devices and diodes in an inverter that drives the electric motor;
modifying reference modulation signals by:
adding the common mode signal to produce clamped modulation signals,
wherein the clamped modulation signals redistribute thermal stress between the switching devices and the diodes while maintaining specified output line-to-line voltage of the electric motor;
comparing the clamped modulation signals with carrier signals using a pulse width modulation generator to generate pulse width modulation gate pulses; and
controlling the switching devices of the inverter using the pulse width modulation gate pulses to drive the electric motor.

2. The method of driving the electric motor of claim 1, wherein junction temperatures of the switching devices and the diodes are reduced during the stall conditions.

3. The method of driving the electric motor of claim 1, wherein stall time capability of the electric motor is increased by redistributing the thermal stress between the switching devices and the diodes.

4. The method of driving the electric motor of claim 1, wherein generating the common mode signal comprises:
determining whether a first absolute value of a phase current corresponding to a maximum voltage value is greater than a second absolute value of the phase current corresponding to a minimum voltage value.

5. The method of driving the electric motor of claim 4, comprising:
selecting the clamp value based on determining whether the first absolute value is greater than the second absolute value; and
providing the common mode signal by either adding or subtracting the clamp value from the maximum or minimum voltage value based on comparing the absolute values of the corresponding three-phase phase currents.

6. The method of driving the electric motor of claim 1, wherein modifying the reference modulation signals comprises:
implementing a carrier-based modulation by injecting the common mode signal into the reference modulation signals.

7. The method of driving the electric motor of claim 1, wherein modifying the reference modulation signals comprises:
implementing a direct switch state vector-based modulation by controlling different combinations of switch states in terms of order and time duration for a given switching frequency.

8. A controller, comprising:
electronic circuitry configured to:
receive voltage reference signals and phase current signals associated with operation of a motor during at least one of stall conditions or low-speed conditions; and
generate reference modulation signals;
a common mode signal generator configured to:
determine maximum and minimum voltage values among the voltage reference signals;
identify corresponding phase currents for phases having the maximum and minimum voltage values;
compare absolute values of the identified phase currents; and
generate a common mode signal based on a clamp value and comparing the absolute values;
a clamp control module configured to:
modify the reference modulation signals by adding the common mode signal to produce clamped modulation signals; and
a pulse width modulation module configured to:
compare the clamped modulation signals with carrier signals to generate pulse width modulation gate pulses for controlling switching devices of an inverter to supply power to the motor.

9. The controller of claim 8, wherein the controller is configured to select the clamp value to balance temperatures between the switching devices and diodes in the inverter.

10. The controller of claim 8, wherein the clamped modulation signals redistribute thermal stress between the switching devices and diodes while maintaining required output line-to-line voltage of the motor.

11. The controller of claim 8, wherein controlling the switching devices reduces junction temperatures of the switching devices and diodes during the stall conditions and increases stall time capability of the motor by redistributing thermal stress between the switching devices and the diodes.

12. The controller of claim 8, wherein controlling the switching devices increases stall time capability of the motor by redistributing thermal stress between the switching devices and diodes.

13. The controller of claim 8, wherein the controller is configured to operate with a two-level inverter topology having two switching devices and two diodes per phase.

14. The controller of claim 8, wherein the controller is configured to operate with a three-level neutral point clamped inverter topology,
wherein the controller reduces neutral point clamped diode temperatures.

15. A work machine comprising:
an electric motor configured to operate in stall conditions and low speed conditions;
an inverter comprising switching devices and diodes configured to supply power to the electric motor; and
a controller configured to:
receive voltage reference signals and phase current signals associated with operation of the electric motor;
generate a common mode signal based on comparing absolute values of the phase current signals corresponding to maximum and minimum values among the voltage reference signals;
modify reference modulation signals by adding the common mode signal to produce clamped modulation signals; and
control the switching devices using pulse width modulation gate pulses generated by comparing the clamped modulation signals with carrier signals.

16. The work machine of claim 15, wherein the controller is configured to:
select a clamp value to balance temperatures between the switching devices and the diodes, wherein the common mode signal is generated based on the clamp value.

17. The work machine of claim 15, wherein the controller is configured to implement carrier-based modulation by injecting the common mode signal into the reference modulation signals.

18. The work machine of claim 15, wherein the controller is configured to implement direct switch state vector-based modulation by controlling different combinations of switch states.

19. The work machine of claim 15, wherein the controller is configured to reduce diode junction temperatures in a two-level inverter topology having two switching devices and two diodes per phase.

20. The work machine of claim 15, wherein the controller is configured to:
maintain required output line-to-line voltage of the electric motor while redistributing thermal stress; and
increase stall time capability of the electric motor.
